(19) United States
(12) Patent Application Publication
(10) Pub. No.: US 2005/0030224 A1
(43) Pub. Date: Feb. 10, 2005

(54) Methods, systems and mobile terminals for vehicle crash detection using a positioning system

(76) Inventor: Robert Koch, Norcross, GA (US)

Correspondence Address: MYERS BIGEL SIBLEY & SAJOVEC, P.A., P.O. BOX 37428, RALEIGH, NC, 27627, US

(21) Appl. No.: 10/636,392

(22) Filed: Aug. 7, 2003

(51) Int. Cl. G01S 5/14

(52) U.S. Cl. 342/357.07

(57) ABSTRACT

A vehicle crash is detected by detecting a crash condition of the vehicle using a Positioning System (PS) receiver (such as a Global Positioning System (GPS) receiver) on the vehicle. A wireless emergency signal may be generated responsive to detection of the crash condition using the PS receiver.

### FIELD OF THE INVENTION

The present invention relates to vehicles and, more particularly, to methods, systems and devices for vehicle crash detection.

### BACKGROUND OF THE INVENTION

Vehicle accidents often occur in which the passenger or passengers are injured to the extent that they are unable to summon help, even if a functioning wireless telephone or other suitable communication device is available. Moreover, the injured passengers are thus also unable to communicate their location. Emergency response personnel therefore may not be able to aid victims of vehicle crashes when the victims cannot summon help and there are no witnesses to summon help on their behalf.

Efforts have been made to address the foregoing problem. For example, the OnStar™ system offered by General Motors Corporation includes a wireless transmitter, an airbag deployment sensor, and a Global Positioning System (GPS) receiver permanently installed on a vehicle. In the event of a crash that causes an airbag to deploy, the transmitter automatically sends a wireless signal to an emergency center to notify the emergency center that an accident has occurred. The transmitter may also send an identification of the vehicle's location to the emergency center, as determined using the GPS receiver. However, for automatic operation, the OnStar hardware may need to be installed on the vehicle and the crash may need to result in deployment of an airbag.

### SUMMARY OF THE INVENTION

According to method embodiments of the present invention, a method for detecting a vehicle crash includes detecting a crash condition of the vehicle using a Positioning System (PS) receiver on the vehicle. The PS receiver may be a Global Positioning System (GPS) receiver. Detecting the crash condition may include monitoring a velocity of the vehicle using the PS receiver on the vehicle, and detecting a deceleration of the PS receiver on the vehicle at a rate greater than a prescribed rate. A wireless emergency signal may be automatically generated responsive to detection of the crash condition using the PS receiver.

According to embodiments of the present invention, a mobile terminal for detecting a vehicle crash includes a Positioning System (PS) receiver, wherein the mobile terminal is configured to detect a crash condition of the vehicle using the PS receiver. The PS receiver may be a Global Positioning System (GPS) receiver. The mobile terminal may be configured to monitor a velocity of the vehicle using the PS receiver when the mobile terminal is on the vehicle, and to detect a deceleration of the PS receiver at a rate greater than a prescribed rate. The mobile terminal may be configured to automatically generate a wireless emergency signal responsive to detection of the crash condition using the PS receiver.

According to further embodiments of the present invention, an emergency crash notification system for detecting a vehicle crash is provided. The system includes an emergency center and a mobile terminal including a Positioning System (PS) receiver. The mobile terminal is configured to detect a crash condition of the vehicle using the PS receiver. The mobile terminal is configured to automatically generate a wireless emergency signal to the emergency center responsive to detection of the crash condition using the PS receiver. The PS receiver may be a Global Positioning System (GPS) receiver. The mobile terminal may be configured to monitor a velocity of the vehicle using the PS receiver when the mobile terminal is on the vehicle, and to detect a deceleration of the PS receiver at a rate greater than a prescribed rate.

According to further embodiments of the present invention, a computer program product for detecting a vehicle crash includes a computer readable storage medium having computer readable program code embodied in the medium. The computer readable program code includes computer readable program code configured to detect a crash condition of the vehicle using a Positioning System (PS) receiver on the vehicle. The PS receiver may be a Global Positioning System (GPS) receiver. The computer program product may include computer readable program code configured to monitor a velocity of the vehicle using the PS receiver on the vehicle, and computer readable program code configured to detect a deceleration of the PS receiver on the vehicle at a rate greater than a prescribed rate. The computer program product may further include computer readable program code configured to automatically generate a wireless emergency signal responsive to detection of the crash condition using the PS receiver.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

FIG. 1 is a schematic block diagram illustrating an emergency crash notification system according to embodiments of the present invention;

FIG. 2 is a front plan view of a mobile terminal according to embodiments of the present invention and forming a part of the system of FIG. 1;

FIG. 3 is a block diagram of the mobile terminal of FIG. 2;

FIG. 4 is a flowchart illustrating operations according to embodiments of the present invention; and

FIG. 5 is a further flowchart illustrating operations according to embodiments of the present invention.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the relative sizes of regions may be exaggerated for clarity. It will be understood that when an element or component is referred to as being “in” or “on” another element, it can be directly in or on the other element or intervening elements may also be present. In contrast, when an element is referred to as being “directly in” or “directly on” another element, there are no intervening elements present.

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof.

As used herein, “Positioning System” or “PS” refers to land-based (terrestrial) positioning systems, space-based (celestial or extra-terrestrial) positioning systems, and combinations thereof. According to some embodiments, the Positioning System is a global positioning system (as discussed in more detail below). According to some embodiments, the Positioning System is a terrestrial positioning system.

As used herein, “global positioning system” and “GPS” refer to any of the global positioning systems which are space-based (celestial) systems employing satellites and computers to measure positions anywhere on the earth. Such global positioning systems may include the global positioning system originally constructed for use by the United States military and subsequently and currently made available for civilian use. Such global positioning systems may include the GLONASS satellite navigation system in Europe. In a global positioning system, a plurality of GPS satellites orbit the earth and emit specially coded radio signals that are received by GPS receivers. A GPS receiver may include a processor configured to process at least certain of these signals (the accuracy of a GPS receiver may be limited by its type (i.e., civilian or military) or sophistication). The GPS receiver receives the radio signals from selected satellites (typically, the closest satellites) and measures the time that the radio signals take to travel from the GPS satellites to the GPS receiver antenna. By multiplying the travel time by the speed of light, the GPS receiver can calculate a range for each of the selected satellites. From additional information provided in the radio signals from the satellites, including each satellite's orbit and velocity, the GPS receiver can calculate the position of the GPS receiver through a process of triangulation. The GPS receiver may also be enabled to compute position, velocity and time.

A “terrestrial positioning system” or “TPS” as used herein may include any suitable land-based system enabling electronic distance measurement. Typically, such systems use time difference and trilateration positioning technique in a manner similar to that discussed above in relation to GPS. However, in the case of TPS's, the signals (e.g., radio signals) are emitted from land-based sources such as cellular base stations or beacon stations. A TPS may itself receive and utilize signals from a GPS.

As will be appreciated by one of skill in the art, the present invention may be embodied as a method and/or an apparatus. The present invention may take the form of an entirely hardware embodiment, an entirely software embodiment (including firmware, resident software, microcode, etc.) or an embodiment combining software and hardware aspects. Furthermore, the present invention may be embodied as a computer program product on a digital storage medium having computer-readable instructions embodied in the medium. Any suitable digital storage medium may be utilized, including a memory device, hard disk, CD-ROM, optical storage device, transmission medium, such as a wireless transmission medium and/or those supporting the Internet or an intranet, and/or a magnetic storage device.

The present invention is described herein with reference to block diagrams and/or flowchart illustrations of methods, apparatus (systems), mobile terminals, and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, a Digital Signal Processor (DSP) and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer, DSP, or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer, DSP, or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

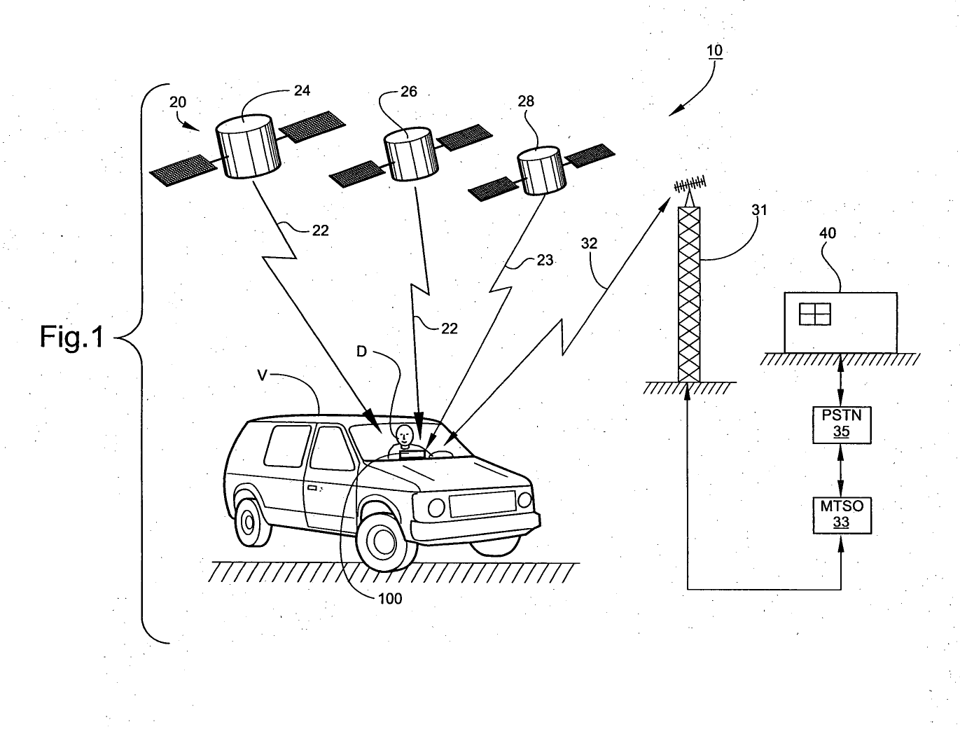

With reference to FIG. 1, an emergency crash notification system 10 according to embodiments of the present invention is shown therein. The system 10 may be used to detect a crash condition of an associated vehicle V and to automatically transmit (directly or indirectly) a wireless emergency signal to a recipient station such as an emergency center 40. According to some embodiments, the system 10 includes a mobile terminal 100 mounted on the vehicle V for movement therewith, a global positioning system (GPS) 20, a terrestrial wireless communication network 30, and the emergency center 40. The global positioning system 20 includes a plurality of GPS satellites 24, 26 (additional GPS satellites may also be employed).

The terrestrial wireless communication network 30 as illustrated is merely exemplary of those that may be employed. The terrestrial wireless communication network 30 may be of any suitable configuration, such as those commonly employed for cellular radiotelephone systems. The terrestrial wireless communication network 30 includes one or more base stations 31 each including a radiotelephone transceiver. The base station(s) 31 are served by a mobile telephone switching office (MTSO) 33. The MTSO 33 is in turn operatively connected to a communications network (for example, a public switched telephone network (PSTN)) 35 via a landline, for example. The emergency center 40 may be operatively connected to the PSTN 35 via a landline, for example. The mobile terminal 100 is adapted to transmit wireless signals (preferably radio signals) 32 to the base station(s) 31, and thereby to the emergency center 40 via the terrestrial wireless communication network 30.

Alternatively or additionally, the mobile terminal 100 may be adapted to transmit wireless signals (preferably radio signals) directly to a wireless transceiver of the emergency center 40. In this case, the terrestrial wireless communication network 30 may be omitted.

As a further alternative, the mobile terminal 100 may be a satellite telephone adapted to transmit wireless signals (preferably radio signals) 23 to one or more transmission satellites 28. The signals may be relayed by the transmission satellite 28 via radio signals to the emergency center 40 directly or through a wireless communication network.

As discussed in more detail below, the wireless mobile terminal 100 includes an associated GPS receiver 120 configured to generate geographical position data using radio signals 22 emitted by the satellites 24, 26 of the global positioning system 20. The position data can be used to detect the crash condition. The position data can also be transmitted by the mobile terminal 100 to the emergency station 40.

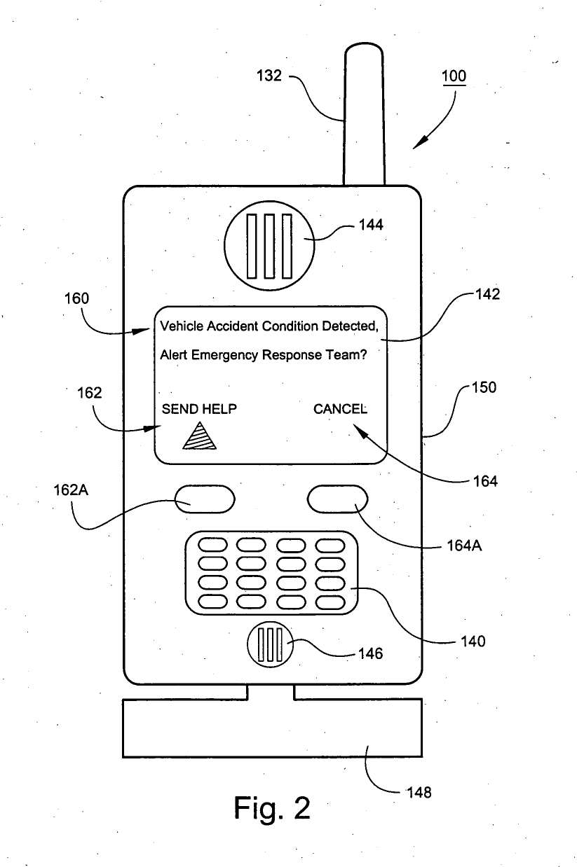

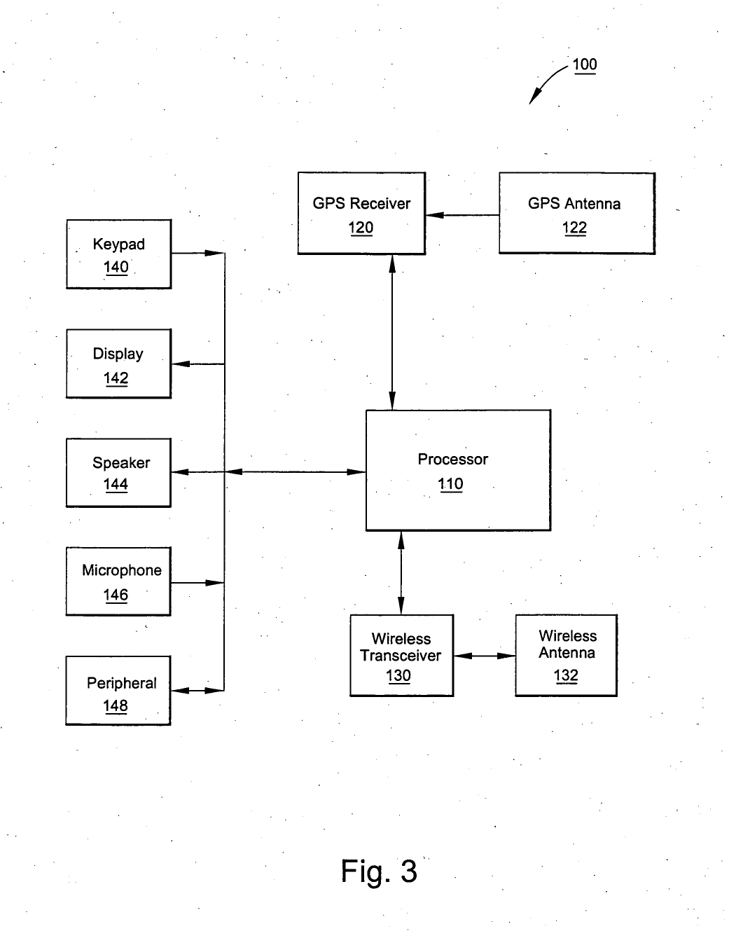

With reference to FIGS. 2 and 3, the mobile terminal 100 may be configured as shown therein in accordance with embodiments of the present invention. As illustrated, the mobile terminal 100 is a handheld radiotelephone. However, as discussed below, the mobile terminal may a device of a type and configuration different than that illustrated in the figures.

The mobile terminal 100 may include a processor 110 and a suitable power supply (not shown). The GPS receiver 120, a GPS antenna 122, a wireless transceiver 130, a radiotelephone antenna 132, a keypad 140, a display 142, a speaker 144, a microphone 146, and one or more peripheral devices 148 are operatively coupled to the processor 110. In conventional manner, the transceiver 130 may include a transmitter circuit and a receiver circuit, which respectively transmit outgoing radio frequency signals to the base station 31 and receive incoming radio frequency signals from the base station 31 via the antenna 132. The radio frequency signals transmitted between the mobile terminal 100 and the base station 31 may comprise both traffic and control signals (e.g., paging signals/messages for incoming calls), which are used to establish and maintain communication with another party or destination. According to some embodiments, the mobile terminal 100 is capable of placing voice calls in accordance with one or more available protocols or standards (e.g., CDMA, TDMA, GSM, voice-over IP, voice-over WiFi, other). The foregoing components are contained in a housing 150 (FIG. 2).

Each of the foregoing components of the mobile terminal 100 (with the exception of the computer readable program code) may be of any suitable construction and arrangement. Suitable apparatus and software for forming the mobile terminal 100 will be readily apparent to those of ordinary skill in the art upon reading the description herein. For example, radiotelephones having GPS receivers and GPS antennas and operable to wirelessly transmit position information acquired using the GPS receiver are known and may be modified as discussed herein to provide the apparatus and functionality and to enable methods of the present invention.

In some embodiments, the mobile terminal 100 is provided with suitable computer readable program code to perform the operational steps described herein. According to some embodiments, the processor 110 includes suitable computer readable program code in the form of software and/or firmware to receive; process, and perform crash detection analysis using position data from the GPS receiver 120. The processor 110 may be further enabled to generate output signals to the display 142 and the speaker 144, to receive signals from the keypad 140 and the microphone 146, to generate and receive signals to/from the wireless transceiver 130, and to process all such signals and associated data as needed. It will be appreciated that various of the code and functionality described in relation to the processor 110 can be allocated to other components and/or further processors. For example, while the processor 110 is described below as determining whether deceleration has occurred, the GPS receiver 120 may instead be operative to perform this function and report the same to the processor 110. In such case, the GPS receiver 120 may be configured to determine velocity and even acceleration/deceleration using the position signals from the satellites 24, 26.

The foregoing components of the mobile terminal 100 (with the exception of the computer readable program code) may be included in many conventional mobile terminals and their functionality is generally known to those skilled in the art. Moreover, as used herein, the term “mobile terminal” may include: a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Intemet/intranet access, Web browser, organizer, and/or calendar; and a conventional laptop and/or palmtop receiver or other appliance that includes a radiotelephone-transceiver. Mobile terminals may also be referred to as “pervasive computing” devices.

According to some embodiments, the mobile terminal 100 is a portable device that can be mounted on and removed from the vehicle V without destruction or significant disassembly of the vehicle V or the mobile terminal 100. In this manner, the mobile terminal 100 can be readily transferred between vehicles. According to other embodiments, the mobile terminal is substantially permanently mounted on the vehicle V. For example, the mobile terminal may be embedded or integrated into the structure of the vehicle (e.g., mounted between the dash and the firewall). According to some embodiments, the several components of the mobile terminal may be separable or contained in different housings but suitably operably connected.

With reference to FIGS. 1 and 3, the mobile terminal 100 is mounted in the vehicle V. In general, the mobile terminal 100 should be located on the vehicle V in such a manner that the GPS antenna 122 is able to receive sufficiently strong signals 22 from the satellites 24, 26 to enable to the GPS receiver 120 to perform its positioning function. As discussed above, the mobile terminal may be a portable device such as a radiotelephone or the like, in which case the occupant D may simply mount the mobile terminal 100 on the vehicle V in any suitable manner. The occupant D may securely mount the mobile terminal 100 on the vehicle V, for example, using a cradle or docking station. Alternatively, the occupant D may loosely mount the mobile terminal 100 on the vehicle V by simply placing the mobile terminal 100 on the dash, in a seat, on the vehicle seat floor, or in a purse, briefcase, apparel (e.g., an article of apparel being worn by the occupant) or the like disposed within the vehicle V, for example. As also discussed above, the mobile terminal 100 may be substantially permanently mounted on the vehicle V, in which case the mobile terminal 100 may be preinstalled and need not be placed by the occupant D. As used herein with regard to placement of the mobile terminal 100, “mounted” means that the mobile terminal is placed on the vehicle (which may include placement within the vehicle) in such a manner that the mobile terminal 100 is conveyed with the vehicle. “Mounted” is not intended to imply that the mobile terminal 100 is necessarily secured to or placed directly in or on the vehicle. As used herein, “on” is intended to include placement of the mobile terminal 100 such that it depends from the vehicle.

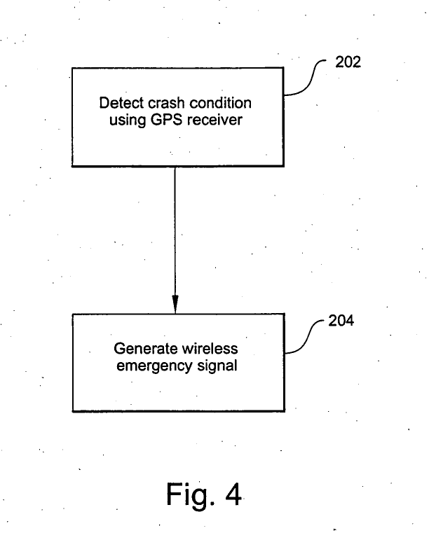

Referring now to FIG. 4, operations according to embodiments of the present invention are illustrated therein. First, the GPS receiver is used to detect a crash condition (Block 202). Certain methods for detecting a crash condition are discussed below; however, the present invention is not limited to such methods. The crash condition may be, for example, deceleration of the GPS antenna 122 at a rate that is indicative of a crash event. Assuming the mobile terminal 100 is properly mounted on the vehicle V, the deceleration of the GPS antenna 122 will correspond to the deceleration of the vehicle V. As used herein, a “crash condition” does not require that an actual crash or other event requiring emergency notification has occurred, only that an event (e.g., sudden deceleration indicative of a crash) has occurred that is deemed to warrant notification.

Once the crash condition has been detected, the mobile terminal 100 generates a wireless emergency signal (Block 204). The emergency signal may be directed to an emergency center such as the emergency center 40 or any other prescribed recipient. The emergency center 40 may be a public service answering point (PSAP) or a private service provider such as the OnStar™ network or the like.

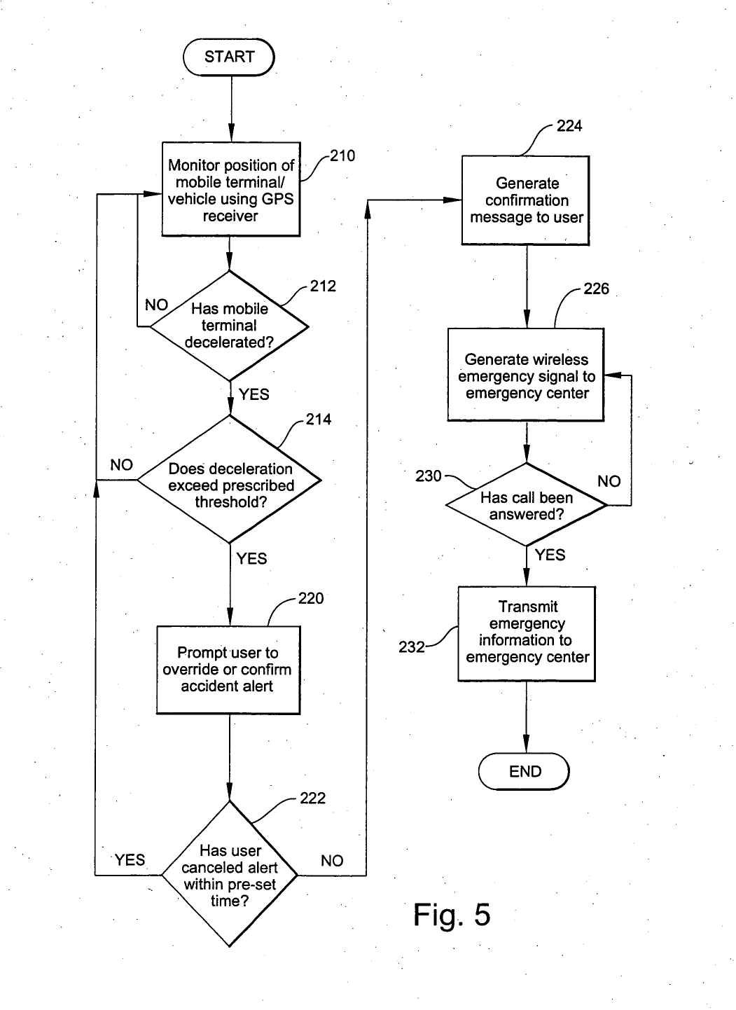

With reference to FIG. 5, further operations in accordance with the present invention and the methods described just above, and which may be accomplished using the mobile terminal 100 and the system 10, will now be described. The GPS receiver 120 monitors the position of the mobile terminal 100, and thereby the position of the vehicle V (Block 210). The processor 110 polls the GPS receiver 120 for position and time data, preferably substantially continuously or at high frequency, to determine whether the vehicle V has decelerated. This determination can be readily made by comparing the position data over time. More particularly, velocity may be calculated using the time and position information calculated from the GPS signal. The GPS signal contains both positioning information and a time stamp tied to each location. Velocity can be estimated by calculating the relative difference between time and location. The acceleration/deceleration can be calculated as the change in the estimated velocity over time. In this manner, the mobile terminal 100 serves as an accelerometer.

If deceleration is not detected, the processor continues to poll the GPS receiver 120 (Block 212). When deceleration is detected, the processor 110 analyzes the position data to determine whether the deceleration exceeds a prescribed deceleration threshold (Block 214). The prescribed deceleration threshold may be a deceleration deemed to correspond to a minimum deceleration value (or an adjusted minimum deceleration) expected to occur in the event the vehicle V is involved in a crash necessitating emergency response. Where an adjusted minimum deceleration is used, the threshold may be the expected minimum deceleration plus or minus some margin to either reduce false-positives (i.e., tendency to trigger under conditions other than a crash) or false-negatives (i.e., failure to trigger in the event of an actual accident). According to certain preferred embodiments, the threshold deceleration is in the range of between about 20 and 50 mph/second.

The prescribed deceleration value may be a constant or may vary depending on other conditions. For example, the threshold deceleration may vary depending on the velocity of the vehicle at the time the vehicle began decelerating. The threshold values may be provided by a lookup tables and/or an algorithm, for example.

If the detected deceleration does not exceed the threshold deceleration value, the processor continues to poll the GPS receiver 120. If the detected deceleration does exceed the threshold deceleration value, the processor 110 initiates an emergency alert sequence as follows.

The processor 110 generates an audible alarm sound from the speaker 144 to audibly notify the vehicle occupant D that a crash condition has been detected and the emergency alert sequence has begun. The processor also generates a message 160 on the display 142 of the mobile terminal 100. The message also notifies the occupant D that a crash condition has been detected and queries the occupant D to either confirm that emergency help is desired or, alternatively, to cancel the emergency sequence (Block 220). More particularly, the processor 110 displays graphics and/or text 162 (“SEND HELP” along with the emergency triangle symbol), 164 (“CANCEL”). The occupant D can press either of the respective corresponding buttons 162A, 164A on the keypad 140 to indicate his or her response.

The processor 110 counts a waiting time period in order to allow the occupant D, if available, to acknowledge and react to the prompt. If the user presses the button 164A within the waiting time period, the processor 110 will abort the emergency sequence and return to monitoring the vehicle position. If the occupant D presses the button 162A within the waiting time period, the processor 110 will proceed to the next step without waiting the remainder of the waiting time period. If, by the end of the time waiting period, the occupant D has not responded, the processor 110 will proceed to the next step. Thus, in the event the occupant D is incapacitated, the processor 110 will proceed automatically. On the other hand, in the event an accident requiring emergency help has not occurred, the occupant D can override the system 10 to prevent the unnecessary deployment of emergency personnel. Even in the event the wait period has timed out, the “CANCEL” button may remain available so that user can abort the emergency sequence even after it has proceeded to the steps that follow. According to some embodiments, the waiting time period is between about 10 and 30 seconds.

If the waiting period expires without response from the user or the user confirms emergency personnel are needed, the processor 110 next generates a confirmatory notification at the display 142 and/or speaker 144 that the wireless emergency signal will be sent to the emergency center 40 (Block 224). The confirmatory notification may include a voice message of “Placing emergency call” or “Sending emergency message” or the like.

The processor 110 further generates the wireless emergency radio signal to the emergency center 40. (Block 226). The wireless emergency signal is generated via the wireless transceiver 130 through the antenna 132, for example, in the same manner as conventional cellular radio frequency wireless transmissions. The telephone number to which the wireless emergency signal call is directed may be a pre-programmed number or “911”. The processor 110 will continue to attempt to access the emergency center 40 until the emergency center 40 answers the emergency signal call (Block 230).

Once the emergency center 40 answers the call from the mobile terminal 100, the processor transmits the emergency information to the emergency center 40 via further wireless signals (Block 232). The emergency information may include an audible voice message, a text message, raw data and/or a coded message. The voice or text message may include a message prerecorded by the user or another. The processor 110 may include a text-to-voice processor for converting information such as location information to a voice message.

The data included in the emergency message may include various user profile, vehicle identification, and accident information such as, without limitation, one or more of the following:
1. GPS location information such as the current location of the mobile terminal 100 as determined by the GPS receiver 120;
2. the user's name;
3. the telephone number of the mobile terminal 100;
4. medical conditions or instructions or other information relating to the user;
5. vehicle identification information (license tag number, year/make/model/color of vehicle);
6. information for use in contacting one or more emergency contacts of the user; and
7. a notification that an accident involving the vehicle has occurred.
   Notably, where the emergency center 40 is not capable of directly uploading GPS position data, the voice and/or text message including location information may provide this information to the emergency center nonetheless. The mobile terminal 100 may be configured to offer additional information. For example, the voice message transmitted to the emergency center may include the statement, “For additional emergency information for this user, press [1]”.”

According to some embodiments, the emergency signal will include only limited information such as the telephone number and/or position of the mobile terminal 100. For example, once a crash condition has been confirmed (either affirmatively by the user or by expiration of the waiting time period), the mobile terminal 100 may operate in the same manner as a conventional E911 mobile terminal, except that the E911 call is initiated automatically and without requiring actuation by the user.

Upon receipt of the emergency information from the mobile terminal 100, the emergency center personnel may place a return call to the mobile terminal 100 to confirm that the occupant D is non-responsive (i.e., incapacitated). Certain of the emergency information may not be initially sent to the emergency center 40, in which case the emergency center may query the mobile terminal 100 for further emergency information. For example, the emergency center 40 may transmit a request to the mobile terminal 100 for location information in accordance with the E911 system protocol. The emergency center may then dispatch emergency personnel to the site of the accident and take other appropriate action using the emergency information.

While the invention has been described above as directing an emergency signal to an emergency center, the mobile terminal 100 may also or alternatively direct the signal to a non-emergency service telephone number. For example, the mobile terminal 100 may automatically send an emergency signal to the telephone of a friend or relative selected by the user or another.

The emergency notification systems of the present invention may be incorporated into or combined with other emergency alert systems. For example, the GPS receiver and GPS antenna may be operably connected to or integrated with an emergency notification system of the type which is actuated by deployment of airbags (e.g., an OnStar™ system). In this case, or when the system already includes a GPS receiver and a GPS antenna, the computer readable program code and functionality described above with regard to the processor 110 may be incorporated into the software and/or hardware of the other system to provide a system and methods in accordance with embodiments of the present invention.

Some cellular telephones and other wireless communication devices of conventional and/or known design include GPS receivers. Such cellular telephones having GPS receivers may be adapted to direct a distress call to an emergency center when a selected key is pressed or telephone number (e.g., 911) is dialed. The distress call may be adapted for cooperation with an Enhanced 911 (E911) system, in which case the distress call includes an identification of the location of the cellular telephone as determined using the GPS receiver of the cellular telephone. However, for the reasons discussed above, this feature may be deficient in the event the accident victim is unable to operate the cellular telephone to initiate the distress call. In accordance with the present invention, the computer readable program code and functionality described above with regard to the processor 110 may be incorporated into the software and/or hardware of a cellular telephone or other wireless communication device of such known or other designs to provide a system and method in accordance with embodiments of the present invention.

In accordance with the present invention, the mobile terminal may be adapted to detect crash conditions other than or in addition to deceleration events. For example, GPS receivers may be adapted to determine the altitude of the mobile terminal. The processor 110 may be adapted to initiate the emergency alert sequence when the altitude of the mobile terminal decreases at a rate greater than a prescribed rate. This rapid decrease in altitude may correspond to a crash event such as driving off of a cliff or other severe dropoff.

While the embodiments described above employ GPS, other embodiments of the present invention may employ other Positioning Systems, such as terrestrial positioning systems, in addition to or in place of GPS. Suitable modifications to the above-described embodiments will be apparent to those of skill in the art upon reading the description herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A method for detecting a vehicle crash, the method comprising:
using a Positioning System (PS) receiver on the vehicle to detect a crash condition of the vehicle.

2. The method of claim 1 wherein the PS receiver is a Global Positioning System (GPS) receiver.

3. The method of claim 1 wherein the PS receiver is a Terrestrial Positioning System (TPS) receiver.

4. The method of claim 1 wherein detecting the crash condition includes:
using the PS receiver on the vehicle to monitor a velocity of the vehicle; and
detecting a deceleration of the PS receiver on the vehicle at a rate greater than a prescribed rate.

5. The method of claim 1 wherein detecting the crash condition includes:
using the PS receiver on the vehicle to monitor an altitude of the vehicle; and
detecting a decrease in the altitude of the PS receiver on the vehicle at a rate greater than a prescribed rate.

6. The method of claim 1 further including automatically generating a wireless emergency signal responsive to detection of the crash condition using the PS receiver.

7. The method of claim 6 including automatically directing the emergency signal to a public service answering point (PSAP).

8. The method of claim 6 including placing a telephone call to a radiotelephone in the vehicle responsive to the wireless emergency signal.

9. The method of claim 6 including deploying emergency personnel to the vehicle responsive to the wireless emergency signal.

10. The method of claim 6 wherein the emergency signal includes a text message.

11. The method of claim 6 wherein the emergency signal includes an audible message.

12. The method of claim 6 wherein the emergency signal includes a notification that an accident involving the vehicle has occurred.

13. The method of claim 6 wherein the emergency signal includes an identification of the location of the vehicle determined using the PS receiver.

14. The method of claim 6 wherein the emergency signal includes at least one of a name, a medical condition, a license plate number, a phone number, and emergency contact information of a user associated with the PS receiver.

15. The method of claim 6 further including generating an alarm signal directed to an occupant of the vehicle to notify the occupant that the crash condition has been detected.

16. The method of claim 15 including providing the occupant an opportunity to prevent or stop the generation of the emergency signal.

17. The method of claim 16 including delaying the generation of the emergency signal for a wait time period following the generation of the alarm signal.

18. The method of claim 15 including providing the occupant an opportunity to confirm that an accident condition has occurred.

19. The method of claim 6 including generating a signal directed to an occupant of the vehicle to notify the occupant that the emergency signal has been or will be generated.

20. The method of claim 1 including removably mounting a mobile terminal on the vehicle, the mobile terminal including the PS receiver.

21. The method of claim 1 including substantially permanently mounting a mobile terminal on the vehicle, the mobile terminal including the PS receiver.

22. A mobile terminal for detecting a vehicle crash, the mobile terminal comprising:
a Positioning System (PS) receiver, wherein the mobile terminal is configured to use the PS receiver to detect a crash condition of the vehicle.

23. The mobile terminal of claim 22 wherein the PS receiver is a Global Positioning System (GPS) receiver.

24. The mobile terminal of claim 22 wherein the PS receiver is a Terrestrial Positioning System (TPS) receiver.

25. The mobile terminal of claim 22 wherein:
a) the mobile terminal is configured to use the PS receiver to monitor a velocity of the vehicle when the mobile terminal is on the vehicle; and
b) the mobile terminal is configured to detect a deceleration of the PS receiver at a rate greater than a prescribed rate.

26. The mobile terminal of claim 22 wherein:
a) the mobile terminal is configured to use the PS receiver to monitor an altitude of the vehicle when the mobile terminal is on the vehicle; and
b) the mobile terminal is configured to detect a decrease in the altitude of the PS receiver at a rate greater than a prescribed rate.

27. The mobile terminal of claim 22 wherein the mobile terminal is configured to automatically generate a wireless emergency signal responsive to detection of the crash condition using the PS receiver.

28. The mobile terminal of claim 27 wherein the mobile terminal includes a wireless transceiver.

29. The mobile terminal of claim 27 wherein the mobile terminal is configured to automatically direct the emergency signal to a public service answering point (PSAP).

30. The mobile terminal of claim 27 wherein the emergency signal includes a text message.

31. The mobile terminal of claim 27 wherein the emergency signal includes an audible message.

32. The mobile terminal of claim 27 wherein the emergency signal includes a notification that an accident involving the vehicle has occurred.

33. The mobile terminal of claim 27 wherein the emergency signal includes an identification of the location of the vehicle determined using the PS receiver.

34. The mobile terminal of claim 27 wherein the emergency signal includes at least one of a name, a medical condition, a license plate number, a phone number, and emergency contact information of a user associated with the PS receiver.

35. The mobile terminal of claim 27 wherein the mobile terminal is configured to generate an alarm signal directed to an occupant of the vehicle to notify the occupant that the crash condition has been detected.

36. The mobile terminal of claim 35 wherein the mobile terminal is configured to provide the occupant an opportunity to prevent or stop the generation of the emergency signal.

37. The mobile terminal of claim 36 wherein the mobile terminal is configured to delay the generation of the emergency signal for a wait time period following the generation of the alarm signal.

38. The mobile terminal of claim 35 wherein the mobile terminal is configured to provide the occupant an opportunity to confirm that an accident condition has occurred.

39. The mobile terminal of claim 27 wherein the mobile terminal is configured to generate a signal directed to an occupant of the vehicle to notify the occupant that the emergency signal has been or will be generated.

40. The mobile terminal of claim 22 wherein the mobile terminal is adapted to be portable and removable from the vehicle.

41. The mobile terminal of claim 22 wherein the mobile terminal is a handheld device.

42. The mobile terminal of claim 41 wherein the mobile terminal includes at least one of a cellular telephone, a pager and a personal data assistant (PDA).

43. The mobile terminal of claim 22 wherein the mobile terminal is adapted to be substantially permanently secured to the vehicle.

44. An emergency crash notification system for detecting a vehicle crash, the system comprising:
a) an emergency center; and
b) a mobile terminal including a Positioning System (PS) receiver, wherein:
the mobile terminal is configured to use the PS receiver to detect a crash condition of the vehicle; and
the mobile terminal is configured to automatically generate a wireless emergency signal to the emergency center responsive to detection of the crash condition using the PS receiver.

45. The system of claim 44 wherein the PS receiver is a Global Positioning System (GPS) receiver.

46. The system of claim 44 wherein the PS receiver is a Terrestrial Positioning System (TPS) receiver.

47. The system of claim 44 wherein:
a) the mobile terminal is configured to use the PS receiver to monitor a velocity of the vehicle when the mobile terminal is on the vehicle; and
b) the mobile terminal is configured to detect a deceleration of the PS receiver at a rate greater than a prescribed rate.

48. The system of claim 44 wherein:
a) the mobile terminal is configured to use the PS receiver to monitor an altitude of the vehicle when the mobile terminal is on the vehicle; and
b) the mobile terminal is configured to detect a decrease in the altitude of the PS receiver at a rate greater than a prescribed rate.

49. The system of claim 44 wherein the mobile terminal includes a wireless transceiver.

50. The system of claim 44 wherein the emergency center includes a public service answering point (PSAP).

51. The system of claim 44 including a relay station, wherein the mobile terminal is configured to transmit the emergency signal to the relay station and the relay station is adapted to re-transmit the emergency signal to the emergency center.

52. The system of claim 51 wherein the relay station includes a terrestrial cellular base station.

53. The system of claim 44 further including a Global Positioning System (GPS) satellite configured to generate position signals to the PS receiver, wherein the PS receiver is configured to use the position signals to determine locations of the vehicle.

54. The system of claim 44 wherein the emergency signal includes a text message.

55. The system of claim 44 wherein the emergency signal includes an audible message.

56. The system of claim 44 wherein the emergency signal includes a notification that an accident involving the vehicle has occurred.

57. The system of claim 44 wherein the emergency signal includes an identification of the location of the vehicle determined using the PS receiver.

58. The system of claim 44 wherein the emergency signal includes at least one of a name, a medical condition, a license plate number, a phone number, and emergency contact information of a user associated with the PS receiver.

59. The system of claim 44 wherein the mobile terminal is configured to generate an alarm signal directed to an occupant of the vehicle to notify the occupant that the crash condition has been detected.

60. The system of claim 59 wherein the mobile terminal is configured to provide the occupant an opportunity to prevent or stop the generation of the emergency signal.

61. The system of claim 60 wherein the mobile terminal is configured to delay the generation of the emergency signal for a wait time period following the generation of the alarm signal.

62. The system of claim 59 wherein the mobile terminal is configured to provide the occupant an opportunity to confirm that an accident condition has occurred.

63. The system of claim 44 wherein the mobile terminal is configured to generate a signal directed to an occupant of the vehicle to notify the occupant that the emergency signal has been or will be generated.

64. The system of claim 44 wherein the mobile terminal is adapted to be portable and removable from the vehicle.

65. The system of claim 44 wherein the mobile terminal is a handheld device.

66. The system of claim 65 wherein the mobile terminal includes at least one of a cellular telephone, a pager and a personal data assistant (PDA).

67. The system of claim 44 wherein the mobile terminal is adapted to be substantially permanently secured to the vehicle.

68. A computer program product for detecting a vehicle crash, the computer program product comprising:
a computer readable storage medium having computer readable program code embodied in the medium, the computer readable program code comprising:
computer readable program code configured to use a Positioning System (PS) receiver on the vehicle to detect a crash condition of the vehicle.

69. The computer program product of claim 68 wherein the PS receiver is a Global Positioning System (OPS) receiver.

70. The computer program product of claim 68 wherein the PS receiver is a Terrestrial Positioning System (TPS) receiver.

71. The computer program product of claim 68 including:
computer readable program code configured to use the PS receiver on the vehicle to monitor a velocity of the vehicle; and
computer readable program code configured to detect a deceleration of the PS receiver on the vehicle at a rate greater than a prescribed rate.

72. The computer program product of claim 68 including:
computer readable program code configured to use the PS receiver on the vehicle to monitor an altitude of the vehicle; and
computer readable program code configured to detect a decrease in the altitude of the PS receiver on the vehicle at a rate greater than a prescribed rate.

73. The computer program product of claim 68 further including computer readable program code configured to automatically generate a wireless emergency signal responsive to detection of the crash condition using the PS receiver.

74. The computer program product of claim 73 including computer readable program code configured to automatically direct the emergency signal to a public service answering point (PSAP).

75. The computer program product of claim 73 wherein the emergency signal includes a text message.

76. The computer program product of claim 73 wherein the emergency signal includes an audible message.

77. The computer program product of claim 73 wherein the emergency signal includes a notification that an accident involving the vehicle has occurred.

78. The computer program product of claim 73 wherein the emergency signal includes an identification of the location of the vehicle determined using the PS receiver.

79. The computer program product of claim 73 wherein the emergency signal includes at least one of a name, a medical condition, a license plate number, a phone number, and emergency contact information of a user associated with the PS receiver.

80. The computer program product of claim 73 further including computer readable program code configured to generate an alarm signal directed to an occupant of the vehicle to notify the occupant that the crash condition has been detected.

81. The computer program product of claim 80 including computer readable program code configured to provide the occupant an opportunity to prevent or stop the generation of the emergency signal.

82. The computer program product of claim 81 including computer readable program code configured to delay the generation of the emergency signal for a wait time period following the generation of the alarm signal.

83. The computer program product of claim 80 including computer readable program code configured to provide the occupant an opportunity to confirm that an accident condition has occurred.

84. The computer program product of claim 73 including computer readable program code configured to generate a signal directed to an occupant of the vehicle to notify the occupant that the emergency signal has been or will be generated.
